(19) United States
(12) Patent Application Publication
(10) Pub. No.: US 2006/0002148 A1
(43) Pub. Date: Jan. 5, 2006

(54) Optical member, backlight assembly having the optical member and display apparatus having the backlight assembly

(76) Inventors: Heu-Gon Kim, Suwon-si (KR); Hea-Chun Lee, Suwon-si (KR); Jae-Ho Jung, Yongin-si (KR); Si-Joon Song, Yongin-si (KR)

Correspondence Address: CANTOR COLBURN, LLP, 55 GRIFFIN ROAD SOUTH, BLOOMFIELD, CT, 06002, US

(21) Appl. No.: 11/154,497

(22) Filed: Jun. 16, 2005

(30) Foreign Application Priority Data
Jun. 25, 2004 (KR) 2004-47974

(51) Int. Cl. F21V 7/04

(52) U.S. Cl. 362/615

(57) ABSTRACT

An optical member includes a light incident surface, a light exiting surface and a plurality of luminance uniformity enhancing members. The light exiting surface is opposite the light incident surface. The luminance uniformity enhancing members are formed on at least one of the light incident surface and the light exiting surface. Each of the luminance uniformity enhancing members includes a recessed surface formed between a first closed loop and a second closed loop surrounding the first closed loop. Therefore, luminance uniformity is enhanced due to the luminance uniformity enhancing member. Furthermore, a distance between a display panel and the backlight assembly may be reduced to decrease volume of a display apparatus, and a luminance of the display apparatus may be enhanced.

### BACKGROUND OF THE INVENTION

1. Field of the Invention

The present invention relates to an optical member, a backlight assembly having the optical member and a display apparatus having the backlight assembly. More particularly, the present invention relates to an optical member capable of enhancing luminance and having smaller volume, a backlight assembly having the optical member, and a display apparatus having the backlight assembly.

2. Description of the Related Art

Generally, a backlight assembly provides a display apparatus with light to display images using the light. An example of a display apparatus that requires external light is a liquid crystal display (LCD) apparatus.

In order to emit light, a conventional backlight assembly employs a light source such as a light emitting diode (LED), a cold cathode fluorescent lamp (CCFL), a flat fluorescent lamp (FFL), etc.

The CCFL and the FFL are employed mainly by large display apparatuses, and LEDs are employed mainly by small display apparatuses.

LEDs have many merits such as high luminance, low power consumption, etc. However, LEDs have low luminance uniformity, therefore, large display apparatuses do not employ LEDs.

A backlight assembly having LEDs arranged in a matrix has been developed recently. A backlight assembly having the LEDs employs a light guide plate disposed over the LEDs. However, the light guide plate in such a backlight assembly increases the volume of the backlight assembly.

### SUMMARY OF THE INVENTION

Exemplary embodiments of the invention include an optical member capable of enhancing luminance uniformity and reducing volume of a backlight assembly.

Exemplary embodiments of the invention further include a backlight assembly having the above-mentioned optical member.

Exemplary embodiments of the invention further include a display apparatus having the above-mentioned backlight assembly.

In one exemplary embodiment of the optical member, the optical member includes a light incident surface, a light exiting surface and a plurality of luminance uniformity enhancing members. The light exiting surface is opposite the light incident surface. The luminance uniformity enhancing members are formed on at least one of the light incident surface and the light exiting surface. Each of the luminance uniformity enhancing members includes a recessed surface formed between a first closed loop and a second closed loop surrounding the first closed loop.

In one exemplary embodiment of the backlight assembly, the backlight assembly includes an optical member, a light source and a receiving container. The optical member includes a first surface, a second surface opposite the first surface, and a plurality luminance uniformity enhancing members. The luminance uniformity enhancing members are formed on the first surface. Each of the luminance uniformity enhancing members includes a recessed surface formed between a first closed loop and a second closed loop surrounding the first closed loop. The light source provides the optical member with light. The receiving container receives the optical member and the light source.

In one exemplary embodiment of the display apparatus, the display apparatus includes a backlight assembly and a display panel. The backlight assembly includes an optical member, a light source and a receiving container. The optical member includes a first surface, a second surface opposite the first surface, and a plurality luminance uniformity enhancing members. The luminance uniformity enhancing members are formed on the first surface. Each of the luminance uniformity enhancing members includes a recessed surface formed between a first closed loop and a second closed loop surrounding the first closed loop. The light source provides the optical member with light. The receiving container receives the optical member and the light source. The display panel is disposed over the backlight assembly to convert a light generated from the backlight assembly into an image containing light.

In another exemplary embodiment of the backlight assembly, the backlight assembly includes an optical member, a plurality of light emitting diodes directing light toward the optical member, and a plurality of luminance uniformity enhancing members formed on the optical member and aligned with the plurality of light emitting diodes.

Therefore, luminance uniformity is enhanced due to the luminance uniformity enhancing member. Furthermore, a distance between the display panel and the backlight assembly may be reduced in order to reduce the volume of the display apparatus, and luminance of the display apparatus may be enhanced.

### BRIEF DESCRIPTION OF THE DRAWINGS

The above and other features and advantages of the present invention will become more apparent by describing in detail the exemplary embodiments thereof, with reference to the accompanying drawings, in which:

FIG. 1 is a plan view illustrating a portion of an exemplary embodiment of an optical member according to the present invention;

FIG. 2 is a cross-sectional view taken along a line I-I′ in FIG. 1;

FIG. 3 is a cross-sectional view illustrating a light reflecting layer formed on a light incident surface of the optical member in FIG. 1;

FIG. 4 is a cross-sectional view illustrating an exemplary embodiment of a backlight assembly according to the present invention;

FIG. 5 is a cross-sectional view illustrating another exemplary embodiment of a backlight assembly according to the present invention;

FIG. 6 is a cross-sectional view illustrating a further exemplary embodiment of a backlight assembly according to the present invention;

FIG. 7 is a cross-sectional view illustrating yet another exemplary embodiment of a backlight assembly according to the present invention;

FIG. 8 is a cross-sectional view illustrating another exemplary embodiment of a backlight assembly according to the present invention;

FIG. 9 is a graph showing a distribution of luminance of an optical member having no luminance uniformity enhancing member formed thereon;

FIG. 10 is a graph showing the distribution of luminance in accordance with a distance between a diffusion plate and the optical member in FIG. 9;

FIG. 11 is a graph showing a distribution of luminance of an optical member having luminance uniformity enhancing members formed thereon;

FIG. 12 is a graph showing the distribution of luminance in accordance with a distance between a diffusion plate and the optical member in FIG. 11; and

FIG. 13 is a schematic cross-sectional view illustrating an exemplary embodiment of a display apparatus according to the present invention.

### DETAILED DESCRIPTION OF THE INVENTION

Hereinafter the embodiments of the present invention will be described in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

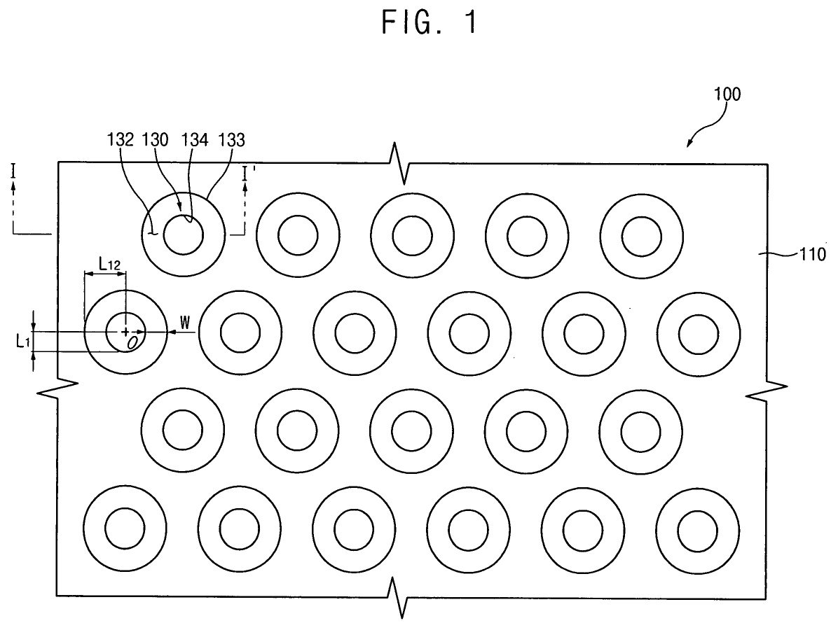

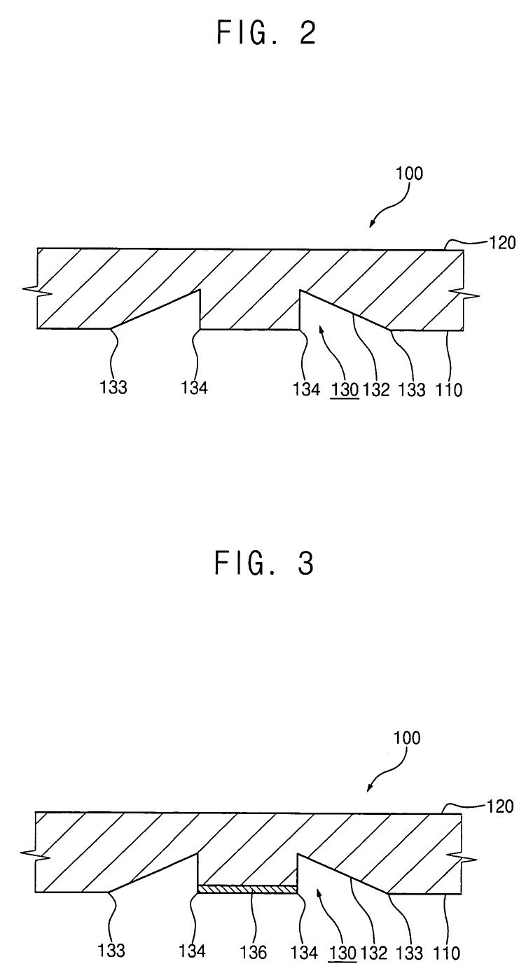

FIG. 1 is a plan view illustrating a portion of an exemplary embodiment of an optical member according to the present invention, and FIG. 2 is a cross-sectional view taken along line I-I′ in FIG. 1.

Referring to FIGS. 1 and 2, an optical member 100 includes, for example, PolyMethylMethAcrylate (PMMA). PMMA, a member of the acrylic family, is a clear and rigid plastic having a high degree of transparency and is often used as a shatterproof replacement for glass. The optical member 100 may correspond to a light guide plate.

In the illustrated embodiment, the optical member 100 has a rectangular plate shape with four side surfaces, a light incident surface 110, and a light exiting surface 120. The four side surfaces connect the light incident surface 110 to the light exiting surface 120, and the light exiting surface 120 faces the light incident surface 110. Both the light incident surface 110 and the light exiting surface 120 have a first area. The area of each of the side surfaces is smaller than the first area. While a rectangular plate shape is illustrated, it should be understood that alternate shapes would be within the scope of the optical member 100.

Light that enters the optical member 100 through the light incident surface 110 exits the optical member 100 through the light exiting surface 120. Light generated from LEDs that are arranged to form a regular pattern will have low luminance uniformity through an optical member having no luminance uniformity enhancing members.

In order to enhance luminance uniformity, the optical member 100 includes at least one luminance uniformity enhancing member 130 formed on one of the light incident surface 110 and the light exiting surface 120. As shown in FIG. 2, and by example only, the luminance uniformity enhancing member 130 is formed on the light incident surface 110. The luminance uniformity enhancing member 130 includes a first closed loop 134, a second closed loop 133 disposed outside the first closed loop 134, and a recessed surface 132 corresponding to a region defined between the first and second closed loops 134 and 133.

The first and second closed loops 134 and 133 may have various shapes. For example, as shown, the first and second closed loops 134 and 133 may have a circular shape resulting in the recessed surface 132 of the luminance uniformity enhancing member 130 having the shape of an annulus, a doughnut shape. The luminance uniformity enhancing member 130 enhances luminance uniformity of light that exits the optical member 100 through the light exiting surface 120.

With the first and second closed loops 134, 133 formed as circular shapes, the luminance uniformity enhancing member 130 formed on the light incident surface 110 corresponds to a circularly depressed portion. Therefore, the luminance uniformity enhancing member 130 includes the first and second closed loops 134 and 133, and the recessed surface 132. Each luminance uniformity enhancing member 130 is disposed such that each luminance uniformity enhancing member 130 corresponds to an LED. In one embodiment, a line passing perpendicularly through the light incident surface 110 and light exiting surface 120 and through a center of the luminance uniformity enhancing member 130 will also pass through a center of the LED that corresponds to that particular luminance uniformity enhancing member 130.

In the illustrated embodiment where the first loop and second loop 134, 133 are circular shaped, the first loop 134 has a first radius L1 and the second loop 133 has a second radius L2 that is greater than the first radius L1. The first and second loops 134 and 133 are concentric.

The width W between the first and second loops 134 and 133 may be adjusted according to a desired amount of light to pass through the luminance uniformity enhancing member 130. When the width W increases, a large amount of light is passed through the luminance uniformity enhancing member 130 as compared to when the width W decreases, a small amount of light is passed through the luminance uniformity enhancing member 130.

The recessed surface 132 is inclined with respect to the light incident surface 110. That is, a depth of the recessed surface 132 at the first loop 134 is deeper than a depth of the recessed surface 132 at the second loop 132. In an exemplary embodiment of the luminance uniformity enhancing member 130, the recessed surface 132 is flat. By example only, the recessed surface 132 may form an angle between approximately 0 and approximately 43 degrees with respect to the light incident surface 110, although other angles outside the above described range may also be used in some embodiments of the optical member 100.

In another exemplary embodiment of the luminance uniformity enhancing member 130, the recessed surface 132 is rounded or otherwise curved (having a curved cross-section) or generally not flat. A boundary region between the recessed surface 132 and the light incident surface 110 may be rounded. Alternatively, one of the boundary regions formed among the first and second loops 134 and 133, and the recessed surface 132 may be rounded. That is, any angled corners between the first and second loops 134, 133 and the recessed surface 132 may be smoothed.

FIG. 3 is a cross-sectional view illustrating a light reflecting layer formed on a light incident surface of the optical member in FIG. 1.

Referring to FIG. 3, the optical member 100 further includes a light reflecting layer 136 formed on a region enclosed by the first loop 134. The light reflecting layer 136 reflects a portion of light advancing toward the region enclosed by the first loop 134.

The optical member described with respect to FIGS. 1-3 may be applied within a backlight assembly having a point like light source such as an LED.

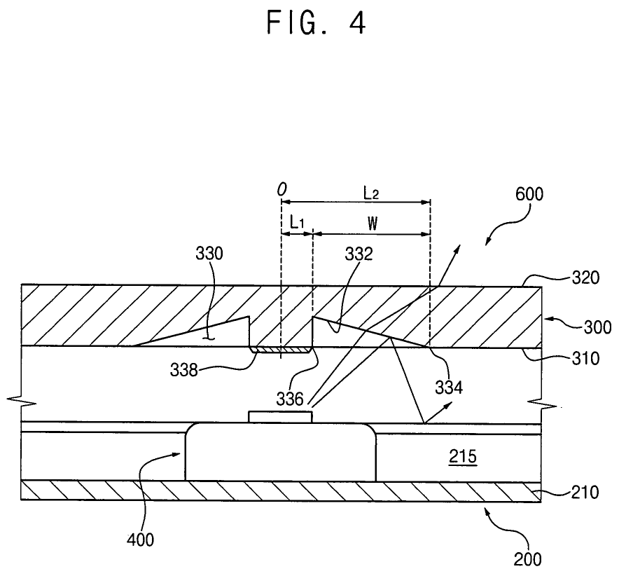

FIG. 4 is a cross-sectional view illustrating an exemplary embodiment of a backlight assembly according to the present invention.

Referring to FIG. 4, a backlight assembly 600 includes a receiving container 200, an optical member 300 having at least one luminance uniformity enhancing member 330, and a light source 400.

The receiving container 200 includes a bottom plate 210 and sidewalls (not shown) that extend from edges of the bottom plate 210. The bottom plate 210 may have various shapes depending on the shape of the display panel. The bottom plate 210 and the sidewalls define a receiving space 215.

The optical member 300 includes, for example PMMA. By example only, the optical member 300 has a rectangular plate shape. Therefore, the optical member 300 has four side surfaces, and first and second opposing surfaces 310 and 320, which may be parallel facing surfaces as shown.

The first surface 310 faces the bottom plate 210 of the receiving container 200. The first and second surfaces 310 and 320 each have a first area that is greater than an area of each of the four side surfaces of the optical member 300.

The luminance uniformity enhancing member 330 is formed on one of the first and second surfaces 310 and 320. In the illustrated embodiment, the luminance uniformity enhancing member 330 is formed on the first surface 310. The luminance uniformity enhancing member 330 includes a first closed loop 336, a second closed loop 334 disposed outside the first closed loop 336, and a recessed surface 332 corresponding to a region defined by the first and second closed loops 336 and 334.

The first and second closed loops 336 and 334 may have various shapes. In one embodiment, the first loop 336 has a circular shape having a first radius L1. The second loop 334 also has a circular shape having a second radius L2 that is greater than the first radius L1. The first and second loops 336 and 334 are concentric.

A width W between the first and second loops 336 and 334 may be adjusted according to a desired amount of light to be passed through the luminance uniformity enhancing member 330. When the width W increases, a large amount of light is passed through the luminance uniformity enhancing member 330. On the contrary, when the width W decreases, a comparatively smaller amount of light is passed through the luminance uniformity enhancing member 330.

The recessed surface 332 is inclined with respect to the first surface 310. That is, the depth of the recessed surface 332 at the first loop 336 is deeper than a depth of the recessed surface 332 at the second loop 334. In one exemplary embodiment, the recessed surface 332 is flat. By example only, the recessed surface 332 may form an angle between approximately 0 and approximately 43 degrees with respect to the first surface 310, although other angles outside of this range would be within the scope of some embodiments of the luminance uniformity enhancing member 330.

The optical member 300 further includes a light reflecting layer 338 formed on a region enclosed by the first closed loop 336. The light reflecting layer 338 reflects light advancing toward the region enclosed by the first loop 336.

A light source 400 is disposed within the receiving container 200 and is positioned between the bottom plate 210 and the optical member 300. The light source 400 is disposed on the bottom plate 210 and faces the first surface 310. An LED may be employed as the light source 400.

The light source 400 is disposed at a region corresponding to a center 0 of the first loop 336. That is, a line passing perpendicularly through the first surface 310 and second surface 320 and through the center 0 of the luminance uniformity enhancing member 330 will also pass through a center of the light source 400 that corresponds to that particular luminance uniformity enhancing member 330. Light generated from the light source 400 advances toward the second surface 320.

A large portion of the light generated from the light source 400 advances toward the luminance uniformity enhancing member 330, and a first portion of the light is reflected from the light reflecting layer 338.

A second portion of the light, which advances toward the luminance uniformity enhancing member 330, is reflected on the recessed surface 332. The remaining third portion of the light enters the optical member 300 through the recessed surface 332, and spreads. Therefore, luminance may be uniformized.

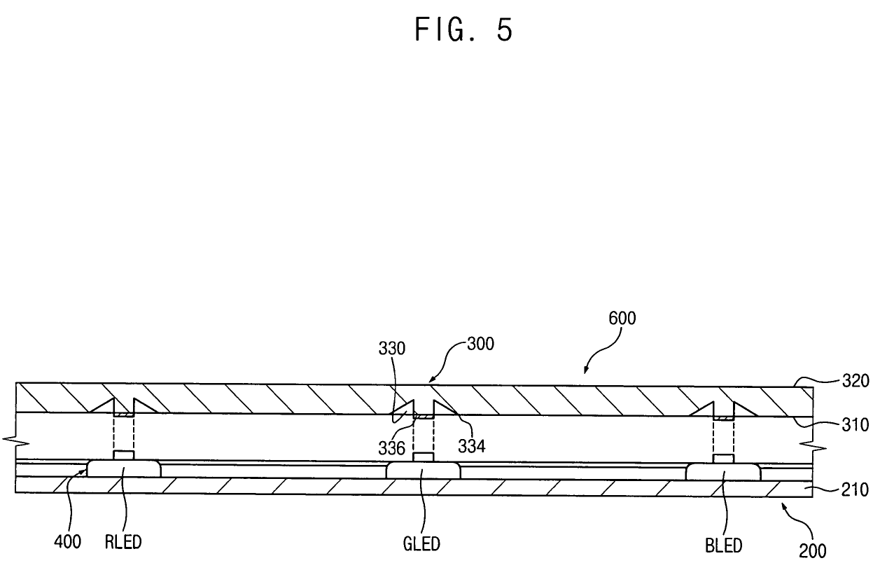

FIG. 5 is a cross-sectional view illustrating another exemplary embodiment of a backlight assembly according to the present invention. The backlight assembly of FIG. 5 is the same as the backlight assembly of FIG. 4 except for the light source. Therefore, the same reference numerals will be used to refer to the same or like parts as those described with respect to the backlight assembly of FIG. 4, and any further explanation will be omitted.

In the illustrated embodiment shown in FIG. 5, the light source 400 of a backlight assembly 600 is arranged on the bottom plate 210 of the receiving container 200. By example only, the light source device 400 includes a red light emitting diode RLED, a green light emitting diode GLED and a blue light emitting diode BLED.

Although only one LED for each color red, green, and blue is illustrated in FIG. 5, a plurality of each color LED are utilized in the backlight assembly 600 and the red, green and blue light emitting diodes RLED, GLED and BLED are arranged in a matrix such that the red, green and blue light emitting diodes RLED, GLED and BLED are alternately disposed on the bottom plate 210 of the receiving container 200.

Alternatively, an LED that generates a white light may be used in place of the red, green, and blue light emitting diodes RLED, GLED, and BLED. In either embodiment, there may be one to one correspondence between the LEDs and the luminance uniformity enhancing members.

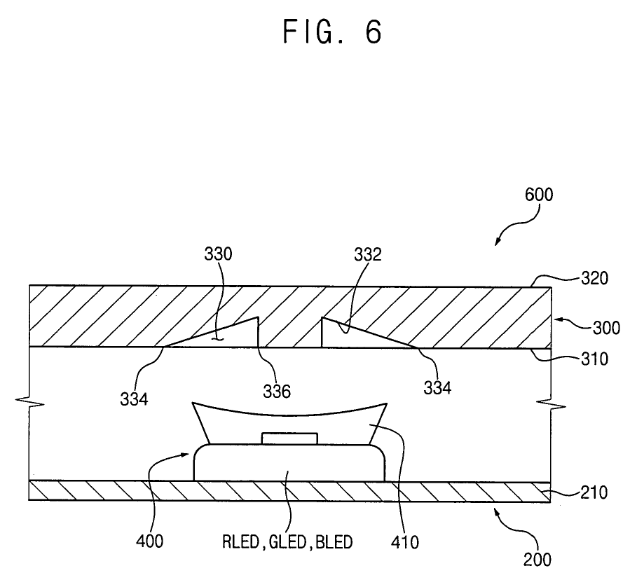

FIG. 6 is a cross-sectional view illustrating another exemplary embodiment of a backlight assembly according to the present invention. The backlight assembly shown in FIG. 6 is the same as the backlight assembly of FIG. 4 except for the light source. Therefore, the same reference numerals will be used to refer to the same or like parts as those described with respect to the embodiment shown in FIG. 4, and any further explanation will be omitted.

Referring to FIG. 6, the light source device 400 may include a red light emitting diode RLED, a green light emitting diode GLED and a blue light emitting diode BLED. Furthermore, the backlight assembly 600 includes a lens 410 positioned with respect to the light source device 400. A center of the lens 410 may be aligned with a center of the light source device 400. The lens 410 may include an outer periphery that is thicker than an inner portion of the lens 410, although other lens shapes for the dispersion of light are within the scope of this embodiment. By employing the lens 410, more portions of light may advance toward the luminance uniformity enhancing member 330 by modulating a path of the light from the light source device 400.

More specifically, light that passes through the lens 410 advances such that the path of the light forms an acute angle with respect to a normal line of a light incident surface of the optical member 300. While the lens 410 is shown with respect to the embodiment of FIG. 6, it should be understood that any of the embodiments disclosed herein may also employ a lens with respect to a light source.

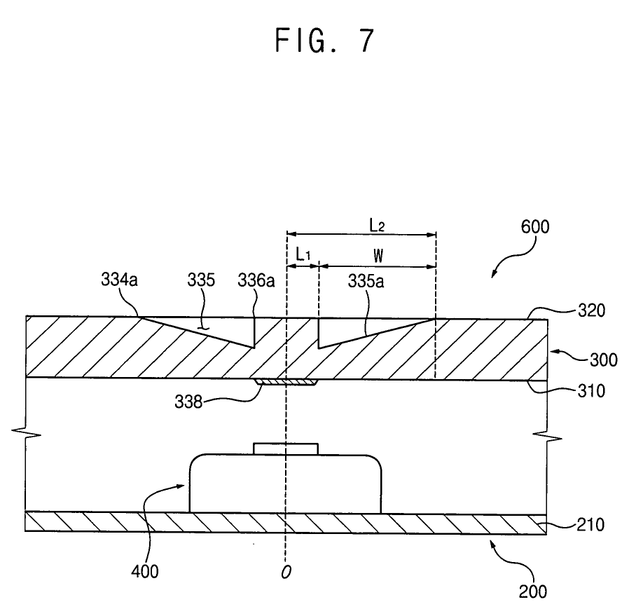

FIG. 7 is a cross-sectional view illustrating another exemplary embodiment of a backlight assembly according to the present invention. The backlight assembly of FIG. 7 is the same as the embodiment of FIG. 4 except for an optical member. Therefore, the same reference numerals will be used to refer to the same or like parts as those described in the embodiment of FIG. 4, and any further explanation will be omitted.

Referring to FIG. 7, the optical member 300 includes a luminance uniformity enhancing member 335 formed on the second surface 320 through which light generated from a light source 400 exits the optical member 300.

The luminance uniformity enhancing member 335 includes a first closed loop 336a, a second closed loop 334a disposed outside the first closed loop 336a, and a recessed surface 335a corresponding to a region defined between the first and second closed loops 336a and 334a.

The first and second loops 336a and 334a may have various shapes. In one exemplary embodiment, the first loop 336a has a circular shape having a first radius L1 and the second loop 334a also has a circular shape having a second radius L2 that is greater than the first radius L1. The first and second loops 336a and 334a are concentric.

A width W between the first and second loops 336a and 334a may be adjusted according to a desired amount of light to be passed through the luminance uniformity enhancing member 335. When the width W increases, a large amount of light is passed through the luminance uniformity enhancing member 335. On the contrary, when the width W decreases, a comparatively smaller amount of light is passed through the luminance uniformity enhancing member 335.

The recessed surface 335a is inclined with respect to the second surface 320. More specifically, a depth of the recessed surface 335a at the first loop 336a is deeper than a depth of the recessed surface 335a at the second loop 334a. In one embodiment, the recessed surface 335a is flat. By example only, the recessed surface 335a may form an angle between approximately 0 and approximately 43 degrees with respect to the second surface 320.

The optical member 300 may further include a light reflecting layer 338 formed on the first surface 310 corresponding to a region enclosed by the first loop 336a. That is, a line extending perpendicularly through the second surface 320 will pass through a center point of the first closed loop and a center of the light reflecting layer 338. The light reflecting layer 338 reflects the light that advances towards the region enclosed by the first loop 336a. Alternatively, the light reflecting layer 338 may be formed on a portion of the second surface 320, which is enclosed by the first loop 336a.

It should be noted that placing the luminance uniformity enhancing members upon the light exiting surface as shown in the embodiment to FIG. 7 may also be applied to any of the other embodiments disclosed herein.

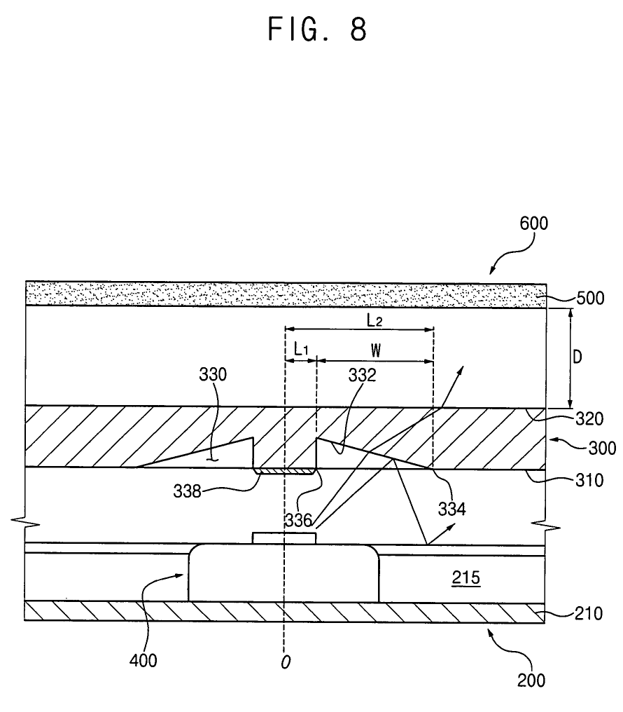

FIG. 8 is a cross-sectional view illustrating another exemplary embodiment of a backlight assembly according to the present invention. The backlight assembly of FIG. 8 is the same as the backlight assembly of FIG. 4 except for a light diffusing plate. Therefore, the same reference numerals will be used to refer to the same or like parts as those described in the embodiment of FIG. 4, and any further explanation will be omitted.

Referring to FIG. 8, a light diffusing plate 500 is spaced apart from an optical member 300 by a distance ‘D’. The light diffusing plate 500 diffuses light that exits the optical member 300 in order to increase luminance uniformity. It should be noted that the other embodiments of the backlight assembly described herein may also utilize a light diffusing plate 500 placed relative to the optical member.

The distance ‘D’ is adjusted in consideration of luminance uniformity and the volume of the backlight assembly. In particular, the distance ‘D’ is optimized to maximize luminance uniformity while minimizing the volume of the backlight assembly.

When the distance ‘D’ increases, luminance uniformity is enhanced, but the volume of the backlight assembly also increases. On the contrary, when the distance ‘D’ decreases, the backlight assembly volume also decreases but the uniformity of luminance deteriorates. Conventionally, the distance ‘D’ is equal to or more than about 50 mm.

However, the distance ‘D’ between the light diffusing plate 500 and the optical member 300 may be reduced by utilizing a luminance uniformity enhancing member 330. Therefore, the volume of the backlight assembly may be reduced, while maintaining the luminance uniformity.

In an embodiment employing the luminance uniformity enhancing members 330, or other uniformity enhancing members described herein, the distance ‘D’ is in a range from about 20 mm to about 30 mm.

Hereinafter, a simulation result of a backlight assembly having no luminance uniformity enhancing member and a backlight assembly having a luminance uniformity enhancing member will be demonstrated and compared.

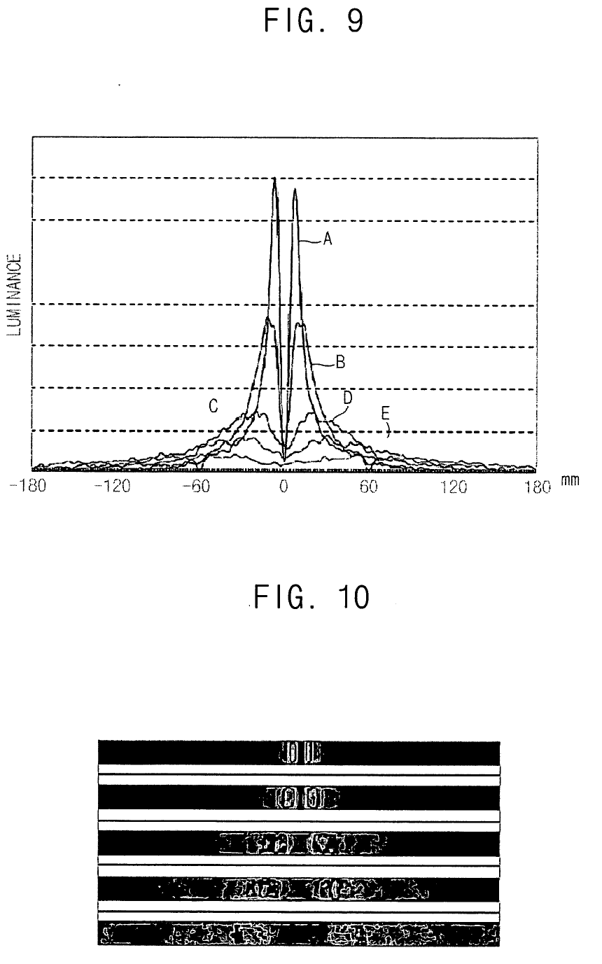

FIG. 9 is a graph showing a distribution of luminance of a comparative optical member having no luminance uniformity enhancing member formed thereon, and FIG. 10 is a graph showing the distribution of luminance in accordance with a distance between a diffusion plate, such as light diffusing plate 500, and the comparative optical member in FIG. 9.

Referring to FIGS. 8 to 10, a light source 400 is disposed under the optical member 300. In an experiment, an LED was employed as the light source 400, and luminance and luminance distribution (uniformity) was measured at points 7 mm, 10 mm, 20 mm, 30 mm and 50 mm along the vertical axis (distances measured with a starting point at the light exiting surface 320 and measured outwardly from the optical member 300) and 0 mm, 40 mm, 80 mm, 120 mm, etc. along the horizontal axis over the optical member 300 (distances measured with a starting point at the center point 0), respectively.

A graph ‘A’ was obtained by measuring the luminance at a point spaced apart from the optical member 300 by 7 mm along the vertical direction. A graph ‘B’ was obtained by measuring the luminance at a point spaced apart from the optical member 300 by 10 mm along the vertical direction. A graph ‘C’ was obtained by measuring the luminance at a point spaced apart from the optical member 300 by 20 mm along the vertical direction. A graph ‘D’ was obtained by measuring the luminance at a point spaced apart from the optical member 300 by 30 mm along the vertical direction. A graph ‘E’ was obtained by measuring the luminance at a point spaced apart from the optical member 300 by 50 mm along the vertical direction.

Luminance in graph ‘A’ is the highest, but uniformity is the lowest. As a distance ‘D’ increases the luminance decreases, but the uniformity increases. Referring to graphs ‘A’ to ‘E’, luminance may become uniform when the distance from the optical member 300 is at least approximately 50 mm, such as shown by graph ‘E’.

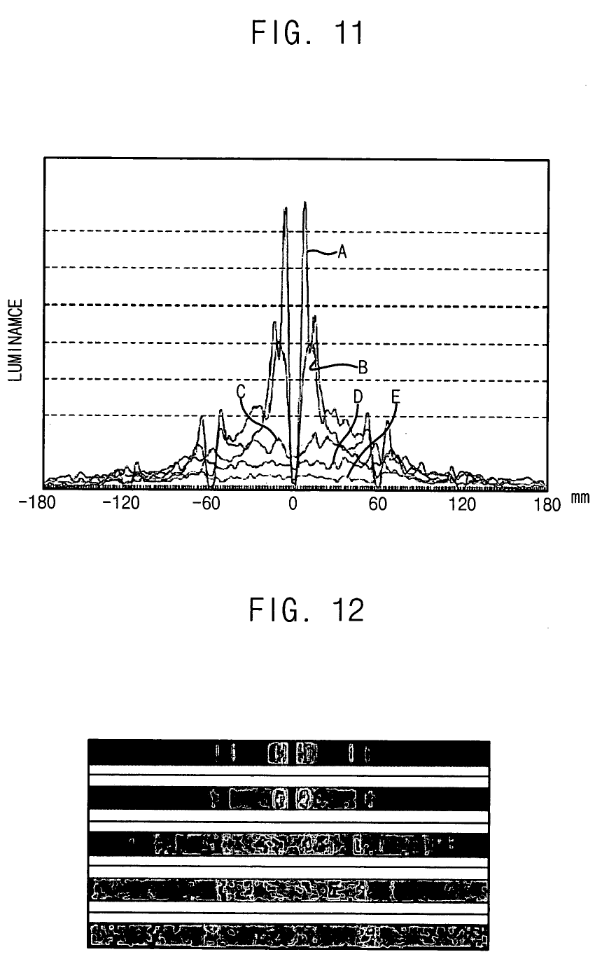

FIG. 11 is a graph showing a distribution of luminance of an optical member having luminance uniformity enhancing members formed thereon, and FIG. 12 is a graph showing the distribution of luminance in accordance with a distance between a diffusion plate, such as light diffusing plate 500, and the optical member in FIG. 11.

Referring to FIGS. 11 and 12, a light source 400 is disposed under the optical member 300. In an experiment, an LED was employed as the light source 400, and luminance and luminance distribution (uniformity) was measured at points 7 mm, 10 mm, 20 mm, 30 mm and 50 mm along the vertical axis (distances measured with a starting point at the light exiting surface 320 and measured outwardly from the optical member 300) and 0 mm, 40 mm, 80 mm, 120 mm, etc. along the horizontal axis over the optical member 300 (distances measured with a starting point at the center point 0 ), respectively.

A graph ‘A’ was obtained by measuring the luminance at a point spaced apart from the optical member 300 by 7 mm along the vertical direction. A graph ‘B’ was obtained by measuring the luminance at a point spaced apart from the optical member 300 by 10 mm along the vertical direction. A graph ‘C’ was obtained by measuring the luminance at a point spaced apart from the optical member 300 by 20 mm along the vertical direction. A graph ‘D’ was obtained by measuring the luminance at a point spaced apart from the optical member 300 by 30 mm along the vertical direction. A graph ‘E’ was obtained by measuring the luminance at a point spaced apart from the optical member 300 by 50 mm along the vertical direction.

Luminance in graph ‘A’ was the highest, but uniformity is the lowest. As the distance ‘D’ increases the luminance decreases, but the uniformity increases.

Referring to graphs ‘A’ to ‘E’, luminance may become uniform when the distance from the optical member 300 is approximately 20 mm, such as shown by graph ‘C’.

Therefore, when the optical member 300 includes a luminance uniformity enhancing member, the distance between the light diffusing member, such as light diffusing plate 500, may be reduced while enhancing luminance.

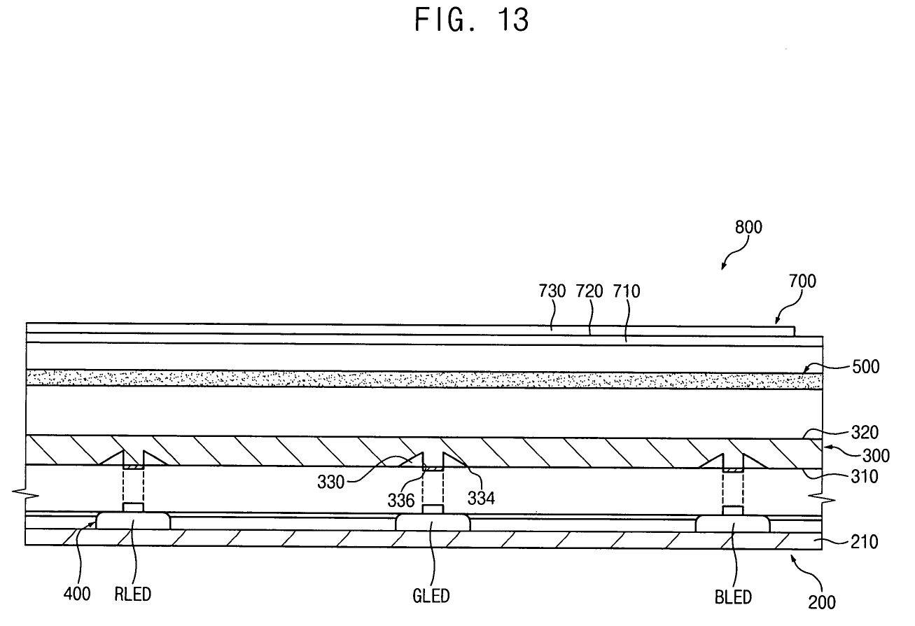

FIG. 13 is a schematic cross-sectional view illustrating an exemplary embodiment of a display apparatus according to the present invention.

Referring to FIG. 13, a display apparatus 800 includes a backlight assembly 600 and a display panel 700. The backlight assembly may be one of the above-described backlight assembly embodiments. Therefore, the same reference numerals will be used to refer to the same or like parts as those described in the embodiment shown in FIG. 4 and any further explanation will be omitted.

The display panel 700 includes a first substrate 710, a second substrate 730 and a liquid crystal layer 720. The first substrate 700 includes a pixel electrode, a thin film transistor (TFT) for applying driving signals to the pixel electrode, and a signal line through which the driving signal is transmitted. The pixel electrode includes an optically transparent and electrically conductive material, for example, such as, but not limited to, indium tin oxide (ITO), indium zinc oxide (IZO), amorphous indium tin oxide (a—ITO), etc.

The second substrate 730 faces the first substrate 710. The second substrate includes common electrode and color filters facing the pixel electrode of the first substrate 710. The common electrode includes an optically transparent and electrically conductive material, such as, but not limited to, indium tin oxide (ITO), indium zinc oxide (IZO), amorphous indium tin oxide (a—ITO), etc.

The liquid crystal layer 720 is interposed between the first and second substrates 710 and 730. Molecules of the liquid crystal layer 720 are rearranged when electric fields are formed between the pixel electrode of the first substrate 710 and the common electrode of the second substrate 730, so that light transmittance of the liquid crystal layer 720 is modulated to display black and white images. Furthermore, when a light that has passed through the liquid crystal layer 720 passes through the color filters, the black and white images are converted into color images.

It should be understood that because the light diffusing plate 500 may be placed closer to the optical member 300 because of the luminance uniformity enhancing members, the display panel 700 may likewise be placed closer to the optical member 300, thus reducing the overall volume of the display apparatus 800.

According to the embodiments described herein, the luminance uniformity enhancing member includes an annular (donut) shaped groove formed on a surface of the optical member. Therefore, luminance uniformity is enhanced. Furthermore, a distance between a display panel and the backlight assembly may be reduced to decrease volume of a display apparatus, and a luminance of the display apparatus may be enhanced.

Having described the exemplary embodiments of the present invention and its advantages, it is noted that various changes, substitutions and alterations can be made herein without departing from the spirit and scope of the invention as defined by appended claims. Various modifications, equivalent processes, as well as numerous structures to which the present invention may be applicable will be readily apparent to those of skill in the art to which the present invention is directed upon review of the instant specification. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An optical member comprising:
a light incident surface;
a light exiting surface opposite the light incident surface; and
a plurality of luminance uniformity enhancing members formed on at least one of the light incident surface and the light exiting surface, each of the luminance uniformity enhancing members including a first closed loop, a second closed loop surrounding the first closed loop, and a recessed surface formed between the first closed loop and the second closed loop.

2. The optical member of claim 1, wherein the first and second closed loops are concentric circles.

3. The optical member of claim 1, wherein a depth of the recessed surface increases in a direction from the second closed loop to the first closed loop.

4. The optical member of claim 3, wherein the depth of the recessed surface is zero at the second closed loop.

5. The optical member of claim 3, wherein the recessed surface forms an angle of about 0 degree to about 43 degrees with respect to the light incident surface and the light exiting surface.

6. The optical member of claim 1, wherein the luminance uniformity enhancing members are arranged to form a regular pattern.

7. The optical member of claim 1, further comprising a light reflecting layer formed on a region enclosed by the first closed loop.

8. A backlight assembly comprising:
an optical member including a first surface, a second surface opposite the first surface, and a plurality of luminance uniformity enhancing members formed on the first surface, each of the luminance uniformity enhancing members including first closed loop, a second closed loop surrounding the first closed loop, and a recessed surface formed between the first closed loop and the second closed loop;
a light source providing the optical member with light; and
a receiving container that receives the optical member and the light source.

9. The backlight assembly of claim 8, wherein the light source includes a light emitting diode.

10. The backlight assembly of claim 9, wherein the light emitting diode is selected from the group consisting of a red light emitting diode, a green light emitting diode, a blue light emitting diode and a white light emitting diode.

11. The backlight assembly of claim 8, further comprising a lens disposed on the light source to decentralize a light generated from the light source.

12. The backlight assembly of claim 8, wherein the first surface of the optical member faces the light source.

13. The backlight assembly of claim 8, wherein the second surface of the optical member faces the light source.

14. The backlight assembly of claim 8, further comprising a light reflecting layer formed on a region enclosed by the first loop.

15. The backlight assembly of claim 8, further comprising a light diffusing member disposed over the optical member, wherein the optical member is positioned between the light diffusing member and the light source.

16. The backlight assembly of claim 15, wherein the light diffusing member is spaced apart from the optical member by a distance in a range of about 20 mm to about 30 mm.

17. A display apparatus comprising:
a backlight assembly including:
an optical member including a first surface, a second surface opposite the first surface, and a plurality of luminance uniformity enhancing members formed on the first surface, each of the luminance uniformity enhancing members including a first closed loop, a second closed loop surrounding the first closed loop, and a recessed surface formed between the first closed loop and the second closed loop;
a light source providing the optical member with light; and
a receiving container that receives the optical member and the light source; and
a display panel disposed over the backlight assembly to convert a light generated from the backlight assembly into an image containing light, wherein the optical member is positioned between the display panel and the light source.

18. The display apparatus of claim 17, wherein the display panel includes a first substrate having pixel electrodes arranged in a matrix shape, a second substrate facing the first substrate and a common electrode formed thereon, and a liquid crystal layer interposed between the first and second substrates.

19. The display apparatus of claim 17, further comprising a light diffusing member spaced from the optical member by a distance in a range of about 20 mm to about 30 mm.

20. A backlight assembly comprising:
an optical member;
a plurality of light emitting diodes directing light toward the optical member; and,
a plurality of luminance uniformity enhancing members formed on the optical member and aligned with the plurality of light emitting diodes.

21. The backlight assembly of claim 20, wherein the optical member includes a light incident face and a light exiting face, and further wherein lines extending through centers of each of the plurality of light emitting diodes and perpendicular to the light incident face also extend through centers of aligned luminance uniformity enhancing members.

22. The backlight assembly of claim 20, wherein each luminance uniformity enhancing member includes:
an inner periphery;
an outer periphery; and,
a recessed surface between the inner periphery and the outer periphery, wherein the recessed surface is more recessed into the optical member adjacent the inner periphery than adjacent the outer periphery.

23. The optical member of claim 22, further comprising a region enclosed by the inner periphery and a light reflecting layer positioned within the region enclosed by the inner periphery.

24. The optical member of claim 22, wherein the recessed surface includes a curved cross-section.

25. The optical member of claim 20, further comprising a plurality of lenses, each lens disposed on one of the plurality of light emitting diodes.

26. The optical member of claim 25, wherein the lens has a thickness at an outer periphery that is thicker than a central portion of the lens.

27. The optical member of claim 22, wherein the recessed surface is annulus-shaped.

28. The backlight assembly of claim 20, wherein the plurality of luminance uniformity enhancing members are aligned with the plurality of light emitting diodes in one to one correspondence.
